(19) United States
(12) Patent Application Publication
(10) Pub. No.: US 2025/0247391 A1
(43) Pub. Date: Jul. 31, 2025

(54) SYSTEMS AND METHODS FOR ASSET IDENTIFICATION

(71) Applicant: Armis Security Ltd., Tel Aviv-Jaffa (IL)

(72) Inventors: Shiri Ladelsky Lellouch, Tel Aviv (IL); Tal Ravid, Tel Aviv (IL); Eyal Nagar, Tel Aviv (IL)

(21) Appl. No.: 19/042,716

(22) Filed: Jan. 31, 2025

Related U.S. Application Data
(60) Provisional application No. 63/627,774, filed on Jan. 31, 2024.

(51) Int. Cl. H04L 9/40

(52) U.S. Cl. CPC H04L 63/0876

(57) ABSTRACT

The present disclosure provides systems and methods for asset identification and consolidation in a network. In some implementations, the methods involve receiving data including a plurality of media access control (MAC) addresses from at least one source, analyzing the received MAC addresses to determine one or more MAC addresses that are repeated in the received data, and labeling the repeated MAC addresses as weak identifiers for asset identification. Some implementations herein enable improved accuracy in identifying and consolidating network assets by distinguishing between reliable and unreliable identifiers, thereby enhancing network security and management capabilities.

### RELATED APPLICATIONS

The present application claims the benefit under 35 U.S.C. § 119(e) of U.S. Provisional Application No. 63/627,774, filed Jan. 31, 2024, which is hereby incorporated herein by reference in its entirety under 37 C.F.R. § 1.57. Any and all applications for which a foreign or domestic priority claim is identified in the Application Data Sheet as filed with the present application are hereby incorporated by reference under 37 C.F.R. § 1.57.

### TECHNICAL FIELD

This application is related to computer security. Some implementations are directed to asset identification. Some implementations are related to identifying characteristics of assets on a network. Some implementations are related to identifying applications present on assets on a network. Some implementations are directed to identifying assets on a network using network activity analysis.

### BACKGROUND

The approaches described in this section are approaches that could be pursued, but not necessarily approaches that have been previously conceived or pursued. Thus, unless otherwise indicated, it should not be assumed that any of the material described in this section qualifies as prior art merely by virtue of its inclusion in this section.

Identifying assets connected to a network has become increasingly challenging as the number and types of networked devices have proliferated. Organizations face difficulties in maintaining accurate inventories of assets, detecting unauthorized or malfunctioning devices, and ensuring network security. Traditional methods of asset identification, such as active network scanning, can be disruptive to certain systems and may not provide a complete picture of all connected devices.

The rise of Internet of Things (IoT) devices, operational technology (OT) systems, and bring your own device (BYOD) policies has further complicated asset identification efforts. Many of these devices cannot run traditional security agent software, leaving them potentially unmanaged and unprotected. Additionally, virtualization technologies and the use of cloud services have made it more difficult to associate network identifiers like MAC addresses with specific physical hardware.

Current approaches to determining characteristics of assets on a network, such as manufacturer, operating system, installed applications, and other attributes, often rely on incomplete or inconsistent information from various sources. Different software tools and platforms may use varying naming conventions or formatting for device and application information, making it challenging to consolidate and analyze data across multiple systems.

Furthermore, the increasing use of technologies like MAC address randomization, while beneficial for user privacy, has made it more difficult for organizations to persistently track and identify devices on their networks. This can lead to issues in maintaining an accurate and up-to-date inventory of connected assets.

As networks grow more complex and diverse, there is a need for improved methods of asset identification and characterization that can work across a wide range of device types and network configurations. Effective asset identification and management are crucial for maintaining network security, ensuring compliance with regulations, and optimizing resource allocation. However, the limitations of existing approaches highlight the need for more robust and adaptable solutions to address the evolving challenges in this field.

### BRIEF DESCRIPTION OF THE DRAWINGS

These and other features, aspects, and advantages of the present disclosure are described with reference to drawings of certain implementations, which are intended to illustrate, but not to limit, the present disclosure. It is to be understood that the attached drawings are for the purpose of illustrated concepts disclosed in the present disclosure and may not be to scale.

FIG. 1 illustrates an example process for analyzing information from a single source according to some implementations.

FIG. 2 illustrates an example process for analyzing information received from multiple sources according to some implementations.

FIG. 3 illustrates an example process for consolidating assets based on shared identifiers according to some implementations.

FIG. 4 is a flowchart that illustrates an example process for sanitizing device names according to some implementations.

FIG. 5 is a flowchart that illustrates an example process for determining primary names of devices according to some implementations.

FIG. 6 is a flowchart that illustrates an example process for enriched asset properties according to some implementations.

FIG. 7 is a diagram that illustrates an example network architecture according to some implementations.

FIG. 8 is a flowchart that illustrates an example process for determining the reliability of a MAC address according to some implementations.

FIG. 9 depicts an example of a process in a flow diagram for training an artificial intelligence or machine learning model.

FIG. 10 illustrates an example of a process for training and using an AI/ML model.

FIG. 11 is a block diagram depicting an implementation of a computer hardware system configured to run software for implementing one or more implementations described herein.

The technologies described herein will become more apparent to those skilled in the art from studying the Detailed Description in conjunction with the drawings. Implementations or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### SUMMARY

For purposes of this summary, certain aspects, advantages, and novel features of the invention are described herein. It is to be understood that not all such advantages necessarily may be achieved in accordance with any particular implementation of the invention. Thus, for example, those skilled in the art will recognize that the invention may be embodied or carried out in a manner that achieves one advantage or group of advantages as taught herein without necessarily achieving other advantages as may be taught or suggested herein.

Some implementations herein are directed to computer-implemented methods for asset identification and consolidation in a network, the computer-implemented method comprising: receiving, by a computing system from at least one source, data comprising a plurality of media access control (MAC) addresses corresponding to each of a plurality of assets in the network; analyzing, by the computing system, the received plurality of MAC addresses to determine one or more MAC addresses of the plurality of MAC addresses that are repeated in the received data; labeling, by the computing system, the repeated MAC addresses for exclusion in identifying each of the plurality of assets within a listing of the plurality of assets in the network.

In some implementations, the at least one source comprises agent-based security software, agentless security software, monitoring software, or an identity and access management (IAM) service. In some implementations, the at least one source comprises a single source.

In some implementations, the method further comprises detecting, prior to receiving data by the computing system, connection of a new asset of the plurality of assets to the network. In some implementations, the method further comprises receiving, by the computing system from the at least one source, one or more additional asset identifiers corresponding to each of the plurality assets in the network; training a machine learning model using training data comprising asset identifiers and relationships between the asset identifiers to generate a trained machine learning model; extracting one or more features from the one or more additional asset identifiers; and inputting the one or more extracted features to the trained machine learning model to determine a classification identifier of each of the plurality of assets in the network.

In some implementations, the one or more additional asset identifier comprises a hardware manufacturer or hardware model and the classification identifier comprising an operating system. In some implementations, the machine learning model comprises a binary classification model. In some implementations, the machine learning model comprises a multi-classification model. In some implementations, the machine learning model comprises a k-nearest neighbors model, decision tree, Naïve Bayes model, random forest, or gradient boosting model. In some implementations, the machine learning model comprises a plurality of binary classification models.

In some implementations, labeling the repeated MAC addresses comprises modifying or adding a field to a database table comprising a plurality of asset identifiers. In some implementations, labeling the repeated MAC addresses comprises adding entries to a table of repeated MAC addresses.

In some implementations, the at least one source comprises a plurality of sources, and the computer-implemented method further comprises: determining a device name associated with each of the plurality of MAC addresses in the received data; determining one or more MAC addresses of the plurality of MAC addresses that are associated with more than one device name; and excluding the one or more MAC addresses of the plurality of MAC addresses that are associated with more than one device name from use as an identifier for asset identification.

In some implementations, the at least one source comprises a plurality of sources, and the computer-implemented method further comprises: determining a device name associated with each of the plurality of MAC addresses in the received data; determining one or more MAC addresses of the plurality of MAC addresses that are associated with more than one device name; and labeling the one or more MAC addresses of the plurality of MAC addresses that are associated with more than one device name as a weak identifier for asset identification.

Some implementations herein are directed to a computer-implemented method for asset identification and consolidation in a network, the computer-implemented method comprising: receiving, by a computing system from a plurality of sources, data comprising a plurality of asset identifiers corresponding to a plurality of assets in the network; determining, by the computing system, a first asset identifier from a first source of the plurality of sources, the first asset identifier corresponding to an asset of the plurality of asset; generating, by the computing system, a first listing of the asset within an asset listing; determining, by the computing system, a second asset identifier from a second source of the plurality of sources corresponding to the asset; generating, by the computing system, a second listing of the asset within the asset listing; identifying, by the computing system, the first identifier and the second identifier in data received from a third source of the plurality of sources; determining, by the computing system, that the first identifier and the second identifier comprise shared identifiers of the asset; and consolidating the asset listing by removing the first listing or the second listing of the asset from the asset listing or merging the first listing and the second listing of the asset in the asset listing.

Some implementations herein are directed to computer-implemented methods for asset identification and consolidation in a network, the computer-implemented method comprising: receiving, by a computing system from a plurality of sources, data comprising a plurality of device names corresponding to each of a plurality of assets in the network; filtering, by the computing system, strings from the plurality of device names, wherein the strings correspond to a list of predetermined device name strings; sanitizing, by the computing system, the filtered device names to determine the device name corresponding to each of the plurality of assets in the network; determining, by the computing system, at least one repeated device name within the sanitized device names; and merging, by the computing the system, the repeated device names in a list of device names corresponding to each of the plurality of assets in the network.

In some implementations, sanitizing the filtered device names comprises: fuzzy matching the filtered device names; calculating a Levenshtein distance between the filtered device names; or using clustering with term frequency-inverse document frequency and bidirectional encoder representations from transformers (BERT) embeddings.

In some implementations, sanitizing the filtered device names comprises identifying a token of the filtered device name based on a calculated maximum entropy measurement of at least a subset of the filtered device names. In some implementations, sanitizing the filtered device names comprises providing the filtered device names in a prompt to a large language model (LLM). In some implementations, the LLM comprises Falcon-7b, Falcon-7b-instruct, OpenLllama, or XGen.

Some implementations herein are directed to systems comprising: at least one hardware processor; and at least one non-transitory memory storing instructions, which, when executed by the at least one hardware processor, cause the system to: perform any of the computer-implemented methods described herein.

Some implementations herein are directed to non-transitory, computer-readable storage medium comprising instructions recorded thereon, wherein the instructions when executed by at least one data processor of a system, cause the system to: perform any of the computer-implemented methods described herein.

### DETAILED DESCRIPTION

Although several implementations, examples, and illustrations are disclosed below, it will be understood by those of ordinary skill in the art that inventions described herein extend beyond the specifically disclosed implementations, example, and illustrations and includes other uses of inventions obvious modifications and equivalents thereof. Implementations of the inventions are described with reference to accompanying figures, wherein like numerals refer to the like elements throughout. The terminology used in the description presented herein is not intended to be interpreted in any limited or restrictive manner simply because it is being used in conjunction with a detailed description of certain specific implementations of the inventions. In addition, implementations of the inventions can comprise several novel features and no single feature is solely responsible for its desirable attributes or is essential to practicing the inventions herein described.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

Asset identification and consolidation technology may serve an important role in managing and securing networked devices in modern, complex IT environments. The implementations herein generally aim to provide organizations with accurate and up-to-date information about the assets connected to their networks.

### Asset Identification and Consolidation

Identifying assets (e.g., laptops, desktops, tablets, smartphones, security cameras, smart speakers, smart lighting, control systems, manufacturing equipment, medical equipment, and so forth) that are connected to a network can be important. For example, companies may have a need for an inventory of assets connected to the network for asset tracking, to identify new or unknown assets, to identify potential security threats, to determine when an asset has been removed from a network (e.g., due to theft, malfunction, or decommissioning), and so forth. Furthermore, as the numbers and types of networked devices increase, and with the popularity of public Wi-Fi, bring your own device (BYOD) policies, and so forth, there is an ever greater need to be able to accurately determine the devices connected to a network.

Various methods exist for identifying devices on a network. For example, network scanning tools can find most or all devices on a network by sending packets to all IP addresses within a specified range and determining which IP addresses respond. While this can be effective, it can have several drawbacks, as such active scanning can consume network resources and may cause instability in some systems such as operational technology (OT) systems (e.g., programmable logic controllers, distributed control systems, computer numerical control systems, building management systems, building automation systems, lighting controls, scientific equipment, medical equipment, and so forth), resulting in downtime, potential lost profits, and even danger to life. Some systems may not be identified or may be incorrectly identified, for example due to the use of technologies such as network address translation (NAT) or Proxy Address Resolution Protocol (Proxy ARP).

In some existing methods, security agents can be installed on some assets, such as laptops, desktops, tablets, and smartphones, and can be used to identify such assets. However, such an approach can omit a significant numbers of assets. For example, there can be hundreds or thousands of devices connected to an enterprise network. These devices can be end-user devices, such as laptops and phones, servers, and so forth that can have agents installed thereon. Devices can also include, for example, Internet of Things (IoT) assets, such as smart TVs, printers, security cameras, vacuums, thermostats, and so forth. In some cases, OT devices may be present on a network. For example, manufacturing equipment, medical equipment, and so forth may be present on a network. While end-user devices and servers may support traditional agent software used for cybersecurity, many OT and IoT assets can be left unprotected and unmanaged, as there may be no way to install an agent on such assets, which may be running custom or stripped down operating systems, may be locked down to prevent the installation of software, and so forth. In some cases, equipment such as laptops, desktops, and servers may not be able to run an agent, for example due to an outdated operating system, an unsupported operating system (e.g., an agent may only exist for the most common operating systems, and a computer may be running a different operating system).

Historically, organizations have relied on quasi-unique identifiers such as media access control (MAC) addresses associated with network interface controllers. However, MAC addresses may not be unique, nor are they necessarily static for a particular asset. Many companies and software producers have implemented measures that can prevent MAC addresses from being reliable for tracking assets. For example, some operating systems, such as macOS, iPadOS, iOS, Windows, Android, and Linux have implemented MAC address randomization. MAC address randomization can offer several benefits to users, such as preventing or limiting persistent tracking of a device by observing Wi-Fi traffic, preventing correlation of information transmitted during Wi-Fi scans with other frames transmitted by the same device (which can be relatively straightforward as Wi-Fi frames include a sequence number that increments with each transmitted frame), and so forth. However, such measures can also make it more difficult for an organization to maintain a complete picture of its network and the assets connected to it, presented potential security risks.

In the past, MAC addresses were typically associated with physical hardware. However, as virtualization and other technologies have become widely adopted, MAC addresses often are not associated with physical hardware. For example, virtual machine software may generate MAC addresses for virtual network interfaces used by virtual machines. In some cases, even if a MAC address is associated with particular hardware such as a physical network interface card, there may be functionality that allows a user to change the MAC address for the hardware or that automatically changes the MAC address over time.

Despite these issues, MAC addresses can still provide some insight into assets on a network. For example, although MAC address randomization is widely available, randomization may not always occur or may only be triggered when specific conditions are satisfied. While virtual network interfaces can be created and destroyed, in some cases they may be relatively stable over time. Thus, while MAC addresses may not be relied on as an authoritative identifier of an asset, they may still be used, for example alongside other information, to uniquely identify assets.

In some implementations herein, the reliability of MAC addresses as unique identifiers can be determined in various ways. For example, in some implementations, a system can be configured to receive MAC addresses from a single data source. The received MAC addresses can include repeating MAC addresses, which can indicate that the MAC address is not unique. Such a MAC address can, in some implementations, be excluded from use as an identifier or can be used as a weak identifier. In some implementations, a system can receive MAC addresses from a plurality of sources. The system can determine names associated with each MAC address. If there are multiple names associated with a MAC address, the MAC address can be excluded from use as an identifier or labeled as a weak identifier. Weak identifiers can still have some value in identifying assets, and in some implementations can be used in conjunction with additional information to uniquely identify assets on a network.

Various other parameters and characteristics of assets can be used to identify assets. For example, operating system (OS), OS version, user agent, protocol usage, port usage, network connections (e.g., connections to an update server, telemetry server, etc.), installed software, and so forth can help to identify assets. However, in isolation, none of these or other parameters and characteristics may be sufficient to uniquely identify an asset. For example, an organization may deploy a fleet of machines that use the same hardware and that have the same software installed (e.g., all users in an accounting department can receive the same laptop with the same accounting software installed).

Often, various software is deployed in a networked environment. For example, in some cases, agent-based security software may be present on an asset. In some cases, agentless security tools can be deployed in a network. In some implementations, there can be other software installed such as user monitoring software. These and/or other types of software can, in some cases, report information such as operating system, computer name, installed applications, application usage, and so forth. In some cases, assets can be joined to a domain, enrolled in a mobile device management service, etc. However, the information provided by these and other sources may not be consistent among different sources. For example, different software or platforms can have different naming conventions for software, can format names in different ways (e.g., whether or not version number is included and if so, whether it is included in separate field or as part of the application name), and so forth. Some applications can format strings using common or friendly names, while others can report an executable name (e.g., “MICROSOFT WORD” versus “winword.exe”).

In some cases, an asset can be joined to a domain or enrolled in an identity and access management (IAM) service (e.g., ACTIVE DIRECTORY, AZURE ACTIVE DIRECTORY, MICROSOFT ENTRA ID, etc.), enrolled in a mobile device management (MDM) platform, and so forth. In some cases, an identifier such as an AMAZON WEB SERVICES (AWS) identifier (AWS ID), ACTIVE DIRECTORY SECURITY IDENTIFIER (AD SID), and/or the like can be associated with an asset.

With multiple sources of information, which may have the same information, different information, inconsistent information, etc., it can be challenging to identify assets uniquely. For example, in some cases, the same asset can have multiple identifications that appear different but in fact represent the same device, virtual machine, etc. For example, one source can have a MAC address and machine name, while another can have machine name and AWS ID. There can be significant consequences if assets are not correctly identified. For example, there can be duplicate assets, missing assets, etc. Thus, a user of a platform that provides asset information may not have an accurate picture of what assets are actually present on a network. For example, as described in more detail herein, without filtering, merging, and so forth, the same asset may appear multiple times, leading to an inaccurately high number of assets being reported. Efforts to reduce the number of duplicate assets can lead to an opposite problem, in which actual assets are removed, leading to underreporting of assets on a network. In either case, customer trust can be compromised, network monitoring activities can be compromised, and so forth. For example, an unauthorized or malicious device may not appear because it appears too similar to a legitimate device and is deduplicated. Accordingly, there is a need for systems and methods that can accurately identify and eliminate duplicate assets while ensuring that different assets are not misidentified as duplicates. In some implementations, assets identified in different sources of data can be merged based on common shared identifiers. In some implementations, data processing can occur on the identifiers before merging, which can help to reduce the number of duplicate assets, reduce the number of incorrectly merged assets, and so forth, as described in more detail herein.

In some implementations, the timing of identifying and/or consolidating an asset can be significant. For example, in some implementations, a system can be configured to determine whether an asset is a new asset when the asset connects to a network. In some implementations, a system can be configured to add a new asset and later determine if the new asset is the same as an existing asset, at which point the new asset and existing asset can be merged. Earlier consolidation can be beneficial as it can improve performance and the overall experience of a system, for example by provided real time or nearly real time information about the assets on a network. However, such immediate consolidation can be difficult as it may take some time to collect sufficient information to identify the asset and/or to find a matching existing asset. Some approaches described herein can improve performance, leading to faster asset identification and consolidation.

### Asset Enrichment

Asset identification can be an important step in understanding the assets on a network. In some cases, after identifying assets, some information may still be missing or unclear. For example, while an asset may be uniquely identified, the asset's primary name may be unknown. As another example, some information about an asset, such as a hardware brand and hardware model (e.g., Apple iPhone) may be known, but another property of the asset may not be explicitly known (e.g., operating system). However, in some cases, properties that are not explicitly known can be inferred. For example, if it is known that a device is an Apple iPhone, it can be inferred that the device is running iOS.

In some implementations, mappings between known attributes and inferred attributes can be defined manually. However, given the large number of devices, configurations, and so forth in existence, a manual approach is unworkable. This can be especially problematic when new devices are added that are not sufficiently similar to existing devices (e.g., cameras from a different vendor).

In some implementations, a machine learning model can be trained using data indicating relationships between asset attributes. In some implementations, the machine learning model can be a binary classification model, for example to differentiate between devices running Windows and devices not running Windows. Binary classification models can use various algorithms, for example, logistic regression, k-nearest neighbors, decision trees, support vector machines, or Naïve Bayes.

In some implementations, binary classification may not be desired. For example, an organization may want to classify between Windows 11 computers, Windows 10 computers, macOS computers, and Linux computers. Algorithms such as k-nearest neighbors, decision trees, Naïve Bayes, random forest, and gradient boosting can be used for multi-classification tasks. In some implementations, binary classification models can be used. For example, multiple binary classification models can be used. In some implementations, a one-vs-rest approach can be used (e.g., individual models can be trained to determine if an asset fits within a particular class or not (e.g., Windows or Not Windows)). In some implementations, a one-vs-one approach can be used. For example, one model can differentiate between Windows and Linux, and another can differentiate between Windows and macOS.

In some implementations, multiple labels may be desired. For example, an asset may be assigned multiple labels such as device model, device manufacturer, operating system, and operating system version. In some implementations, multi-label decision trees, multi-label random forests, or multi-label gradient boosting can be used. In some implementations, multiple models can be used. For example, a first model can classify device manufacturer and a second model can classify operating system.

In some cases, some types of assets may be much more common than other types of assets. For example, an organization may operate almost entirely on computers using Windows but have a small engineering group that uses Linux or a media group that uses macOS, or an organization may have thousands of computers but only a few dozen networked security cameras. As another example, a hospital may have many laptops and smartphones, but only one or two MRI machines.

This can present a significant issue for classification, as relatively rare assets may not be classified correctly, for example due to a lack of training data that can be used to train a model to identify such assets. In some implementation, specialized approaches can be used for training models with imbalanced data. For example, in some implementations, random undersampling or synthetic minority oversampling technique (SMOTE) can be used. In some implementations, specialized models can be used, such as cost-sensitive logistic regression, cost-sensitive decision trees, or cost-sensitive support vector machines. In some implementations, performance of a model can be monitored using metrics such as precision, recall, and f-score (which can be determined from precision and recall data).

### Application Identification

In some implementations, it can be significant to determine applications installed or running on assets. Information about the applications on an asset can help to uniquely identify the asset, as different assets can have different software installed. It can also be significant for an organization to know which applications are installed on assets connected to the network. For example, an organization may want to detect the use of unauthorized software, to detect when a software application has a known security issue, and so forth. While operating systems often provide functionality that can be used to prevent users from installing arbitrary programs, some users may have permissions that allow them to install software. In some cases, users may run programs that do not require installation.

Knowledge of the applications installed on an asset can have significant security implications. For example, an asset may have an unsupported operating system installed, have out of date applications installed, have unauthorized applications installed, and so forth. It can be difficult to determine an accurate listing of applications installed on an asset. Information can come from many sources, such as from an agent installed on an asset, a mobile device management platform, a security platform, etc. In some cases, one source may be reliable while another may not. For example, in some cases, an agent or other software may look in the global applications directory (e.g., /Applications, % PROGRAMFILES %, % PROGRAMFILES (X86) %, etc.) and associated locations/files (e.g., /Library in macOS or the registry in Windows) but may not check other locations where programs may be located, such as a user's home directory, /opt/homebrew in macOS, etc. . . . Different sources of application information may have different strengths and weaknesses, and a combination of sources may be used to determine the applications installed on an asset.

Application name data, operating system data, and so forth can be complex. For example, there can be multiple naming conventions (e.g., MOZILLA FIREFOX, MOZILLAFIREFOX, and FIREFOX can all represent the same application), different languages, different punctuation, etc. For example, a WINDOWS installation can be identified as Windows 11 Pro in one source and Windows_11_Pro_enUS in another source.

In some implementations, a classification model can be used to identify applications or operating systems. For example, a classifier can be trained to map “Windows 11 Pro,” “Windows_11_Pro,” “Windows_11_Pro_enUS,” and so forth to a common classification (e.g., “Windows 11 Pro”). This can help with asset deduplication by achieving uniform application naming conventions regardless of the particular conventions or formats used by software that collects information about installed applications, operating systems, and so forth.

It will be appreciated with that large numbers of applications and often multiple versions of each application, it would be impossible to manually define a mapping between reported names and a common or base name. Indeed, many applications may be unknown outside an organization as they are written specifically by or for the organization and not published elsewhere. In some implementations, a base name can be determined based on common strings reported in different sources of information, obviating the need to manually define base names for applications.

### Asset Identification via Network Monitoring

In some implementations, network monitoring can be used to identify assets on a network. In some implementations, network monitoring can be passive. For example, rather than or in addition to active scanning (e.g., sending pings to a range of IP addresses and listening for responses, port scanning, etc.), passive scanning can monitor existing network traffic to determine which devices are connected to the network. In some implementations, a network monitoring service can operate on a switch deployed inside a network. however, network switches can offer limited monitoring functionality, and monitoring functionality can vary amount networking switching manufacturers, platforms, and so forth.

In some implementations, a collector can be deployed within a network to monitor network activity. In some implementations, a Switched Port Analyzer (SPAN) port on a switch or router can be used to intercept network traffic. A SPAN port is a dedicated port on a network switch that allows a network administrator to monitor network traffic by creating a copy of packets passing through other specified ports on the switch and sending them to the SPAN port for analysis. In some implementations a network tap can be used to intercept network traffic. Using a SPAN port can have several advantages. For example, a SPAN port can be built into a switch or other networking hardware, can be enabled or disabled easily without physical modification to a network, and can be invisible on a network. Using a SPAN port can avoid increasing the number of points of failure on a network. However, using a SPAN port can have some drawbacks. For example, a SPAN port is typically given a lower priority than other ports, which can result in dropped packets. A misconfigured switch can result in limited visibility. Using a network tap can have various advantages and disadvantages. For example, a network tap can be a device that is placed in a network between two pieces of hardware (e.g., routers, switches, firewalls, endpoints, etc.). The network tap can be used to monitor network data. The network tap can provide direct access to network traffic, improving visibility, can avoid adding additional load to a switch or router, and so forth. However, using a network tap can require additional hardware, which can have significant costs, introduce an additional potential failure point into a network, and so forth. For example, a failure of the network tap can cause one or more assets on the network to be unreachable.

While some approaches to monitoring network traffic are known in the art, extracting insights from the monitoring network traffic can be difficult. For example, devices on the network can be misidentified if an IP address is reassigned to a different device (for example by a DHCP server) or if certain networking technologies such as network address translation (NAT), Proxy ARP, etc., are used. Such issues can lead to multiple devices being associated with the same IP address, multiple devices being associated with the same MAC address, and so forth. For example, if NAT or Proxy ARP are used, multiple devices may all appear to be producing traffic from a single IP address or MAC address, depending upon where network monitoring functionality is deployed within a network. If an IP address is associated with a particular MAC address and the IP address is later reassigned to a different device, the different device may not be detected for some time, it may appear that there are multiple devices with the same IP address, and so forth. These issues can lead to inaccurate device identification, devices not being identified (e.g., because they are hidden behind Proxy ARP or NAT), and so forth. This can lead to inaccurate device inventories, inaccurate network traffic analysis (e.g., it may appear that a single device is running multiple operating systems, is both a client and a server, is both a laptop and a mobile phone, etc.), and so forth. In some implementations, it can be significant to accurately identify the devices on a network, even in circumstances where technologies such as DHCP, NAT, and Proxy ARP are deployed in order to have an accurate device inventory, accurately detect the network activity of each device on a network, and so forth. Accurate network activity detection can, for example, enable discovering malicious or suspicious activity more easily. Additionally, accurate device detection can enable detecting added devices, removed devices, etc., more easily, even in cases where a device is connected through networking hardware that would ordinarily conceal the identity of the device.

While network traffic can generally readily be identified with a particular IP address, since IP addresses are typically not constant, it can be important to identify network traffic with another identifier that is unique to a particular device. In some implementations, MAC addresses can be used to uniquely identify devices. In some implementations, other information can be used to uniquely identify a device. While MAC addresses are often considered a good device property for uniquely identifying devices, in some cases MAC addresses may not be constant. For example, virtual machines can have software-generating MAC addresses that may change. Many operating systems implement MAC address randomization, for example in order to prevent or limit tracking of devices. Notwithstanding these limitations, MAC address can still be used to identify devices, either alone or in combination with other device properties (e.g., manufacturer, operating system, model number, serial number, Amazon Web Services ID, Active Directory SID, etc.).

In some implementations, a temporary mapping between IP addresses and MAC addresses can be generated. The temporary mapping can expire after a set period of time. In some implementations, the expiration time can be defined by an organization. For example, an organization with IP addresses that are frequently reassigned to different devices can set a shorter expiration time for the temporary mapping. In some implementations, an expiration time can be limited by a DHCP lease duration.

In some implementations, address resolution protocol (ARP) can be used to associate a link layer address (e.g., a MAC address) with a network layer address (e.g., IP address). ARP tables can be used in IPv4 networks. Similarly, in IPv6 networks, neighbor discovery protocol (NDP) can be used to map a link layer address to a network layer address.

In some implementations, a device identification solution can use integrations with switches, routers, and other networking hardware to identify devices on a network. For example, a switch can have stored thereon a mapping of IP addresses and MAC addresses. In some implementations, a packet can include a device name but may not include a MAC address. In some implementations, the systems and methods herein can translate an IP address to a MAC address. In some implementations, the device name can be extracted from a packet and the device name can be associated with the IP address.

As described herein, various sources of information can be used to map IP addresses and MAC addresses, IP addresses and device names, MAC addresses and device names, and so forth. In some implementations, a first source can conflict with a second source. In some implementations, prioritization logic can be used to determine a priority for sources. For example, an ARP table may take precedence over another source of information, such as a mapping provided by a DHCP server. In some implementations, newer information can take precedence over older information. For example, if a first source was updated five minutes ago and a second source was updated ten minutes ago, the first source can have priority over the second source.

In some implementations, mappings can be updated continuously. In some implementations, mappings can be updated periodically. For example, continuous updating may result in excessive loads on switches, routers, DHCP servers, and so forth. Thus, it can be desirable to extract data from such sources on a periodic basis. In some implementations, the systems and methods herein can include a mechanism to delay updating a MAC address associated with an IP address in case there may not be a valid mapping between the IP address and the true MAC address. For example, if a first device with a first MAC address received an IP address from a DHCP server and subsequently left the network, the DHCP server can assign the same IP address to a second device having a second MAC address. However, if the mapping of IP addresses and MAC addresses has not been updated since the IP address was reassigned, the mapping of the IP address to MAC address may be incorrect (e.g., may still reflect the first device, rather than the second device).

As described herein, Proxy ARP can present a significant challenge when mapping IP addresses to devices. Proxy ARP can be commonly used in networks and can mask the true device from which network data is being sent or received. In some cases, Proxy ARP can be enabled by default on a router. In some cases, Proxy ARP may be used to mitigate the effects of a network configuration issue. In some implementations, some endpoint devices may not be aware of an actual subnet mask. When Proxy ARP is used, a router can provide its own MAC address as the MAC address associated with an IP address of a device connected to the router. However, the IP address of the device may not actually be associated with the router but may instead by associated with a device connected to the router.

Accordingly, it can be significant to detect invalid or unreliable mappings that may result from the use of networking features such as Proxy ARP. In some implementations, one or more of several approaches can be used to determine an invalid or unreliable mapping. In some implementations, if the same MAC address is mapped to more than a threshold number of IP addresses in less than a threshold amount of time, a system can be configured to assume that the mapping is unreliable or invalid and may not use the mapping to associate network traffic with a particular device (e.g., with a particular MAC address). The threshold amount of MAC addresses can vary. For example, in some implementations, the threshold amount of MAC addresses can be 1, 2, 3, 4, 5, 6, 7, 8, 9, 10 or more MAC address. In some implementations, the threshold amount of time can vary. For example, in some implementations, the threshold amount of time can be 1 minute, 2 minutes, 4 minutes, 5 minutes, 6 minutes, 7 minutes, 8 minutes, 9 minutes, 10 minutes, 15 minutes, 30 minutes, 1 hour, 2 hours, any value between these values, or more. For example, in some implementations, a system may be configured to flag a MAC address as unreliable if more than three MAC addresses have been detected for a same IP address within 10 minutes.

In some implementations, a system can be configured to apply default rules based on the networking hardware present. For example, if it is known that a particular manufacturer turns on Proxy ARP by default, any IP address to MAC address mappings for devices connected to such hardware may be flagged as unreliable or invalid. In some implementations, other sources of information can be used to determine whether a MAC address is the true MAC address associated with the IP address.

In some implementations, a system can be configured to flag a mapping between an IP address and a MAC address as unreliable based on device profiles. For example, in some implementations, a system can be configured to detect conflicts in network data associated with a particular IP address or MAC address. For example, in some implementations, packets from a particular IP address may appear to be from both a computer running Windows and a smartphone running iOS. In some implementations, network data may show conflicting device names. In some implementations, network data may show conflicting user agents (though user agents may be unreliable). In some implementations, network data may show characteristics of multiple types of devices. For example, a device that is connecting to a mobile app store can be unlikely to also be running an SSH server or attempting to connect to a Windows update server.

Typically, IP addresses can be unique within a network. However, in some implementations, an IP address can be used by more than one device. For example, the same IP address can be used within different areas of a network. With a multi-layer network, duplicate IP addresses can arise depending upon where network monitoring is performed. For example, if a network is monitored at the distribution layer, it can be more likely that there can be duplicate IP addresses. In some implementations, the systems and methods herein can be configured to parse the network data to determine a plurality of devices associated with a particular IP address, for example by inspecting device names, user agents, or other information.

### Example Implementations

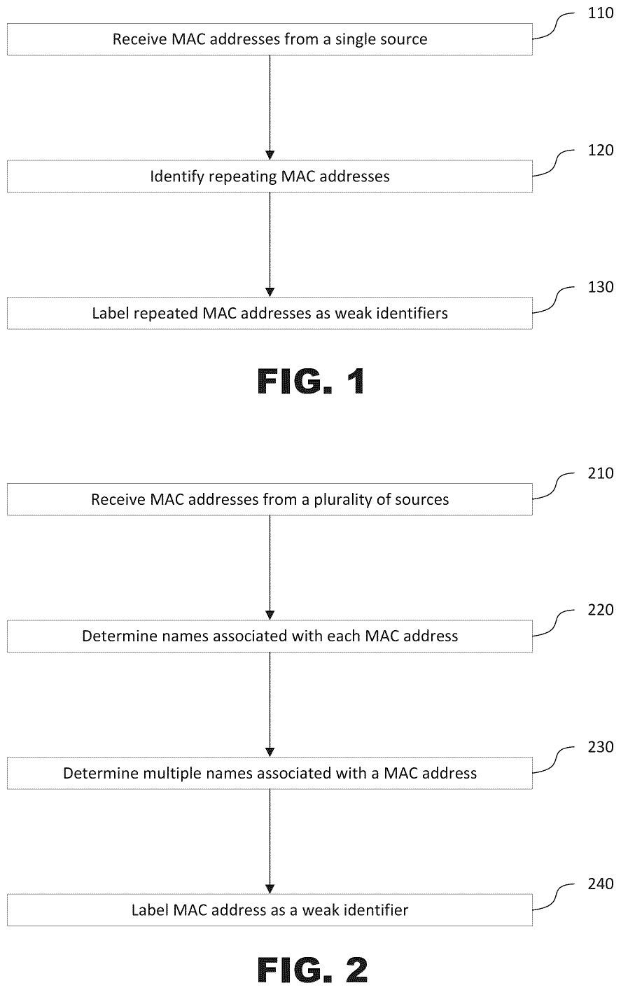

FIG. 1 illustrates an example process for analyzing information from a single source according to some implementations. The process of FIG. 1 can be carried out on a computing system.

At step 110, the system can receive data including a plurality of MAC addresses from a single source. At step 120, the system can analyze the received MAC addresses to determine one or more MAC addresses that are repeated in the received data. At step 130, the system can label the repeated MAC addresses. For example, the repeated MAC addresses can be labeled as weak identifiers, labeled for exclusion for use in identifying assets, and so forth. In some implementations, labeling repeated MAC addresses can include modifying or adding a field to a database table to indicate that a MAC address is a weak identifier. In some implementations, labeling repeated MAC addresses can comprise adding entries to a table of repeated MAC addresses. In some implementations, repeated MAC addresses can be deleted.

FIG. 2 illustrates an example process for analyzing information received from multiple sources according to some implementations. The process of FIG. 2 can be carried out on a computing system.

At step 210, the system can receive MAC addresses from a plurality of sources, which can include one or more third party sources. At step 220, the system can determine names (e.g., asset names) associated with each MAC address. At step 230, the system can determine that there are multiple names associated with a single MAC address. At step 240, the system can label the MAC address as a weak identifier, as an identifier that should be excluded for asset identification, etc.

As described herein, in some cases, different sources of information may contain different strong identifiers. For example, an asset may have associated therewith an AWS ID and an AD SID. A first data source may return the AWS ID associated with the asset and a second data source may return the AD SID associated with the asset. A third source can return both the AWS ID and the AD SID. Given this third piece of information, a system can determine that the AD SID and AWS ID are associated with the same asset, and the AWS ID and AD SID can be associated with one another such that the AWS ID and AD SID identify a single asset.

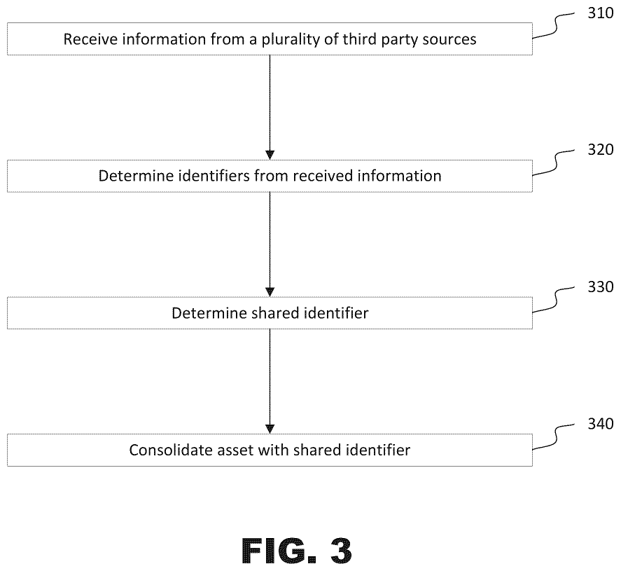

FIG. 3 illustrates an example process for consolidating assets based on shared identifiers according to some implementations. The process shown in FIG. 3 can be performed on a computing system.

At step 310, the system can receive information from a plurality of sources, which can include third party sources. At step 320, the system can determine identifiers from the received information. For example, the system can determine a first identifier from a first third party source and a second identifier from a second third party source. With only this information, the system may not be able to determine that the first identifier and the second identifier are associated with the same asset. In some implementations, there can be a third source that provides both the first identifier and the second identifier. At step 330, the system can analyze the identifiers to determined shared identifiers of an asset. Continuing with the example, the first identifier and second identifier can be identifiers shared by a single asset. At step 340, the system can consolidate the asset with the shared identifiers. For example, if, in the past, only the first and second sources were available and thus an asset appeared twice in an asset data store, the system may, with information from the third data source, merge the assets together into a single asset associated with both the first identifier and the second identifier.

In some implementations, device names can be used to identify assets. However, device names may differ between sources. For example, one source may report a device name as [DOMAIN]\[DEVICENAME], another may report a device name as [DEVICENAME]. [DOMAIN], and another may report a device name as [DEVICENAME]. In some cases, a third party source may report a device name with a third party-specific prefix or suffix, may truncate a device name, and so forth.

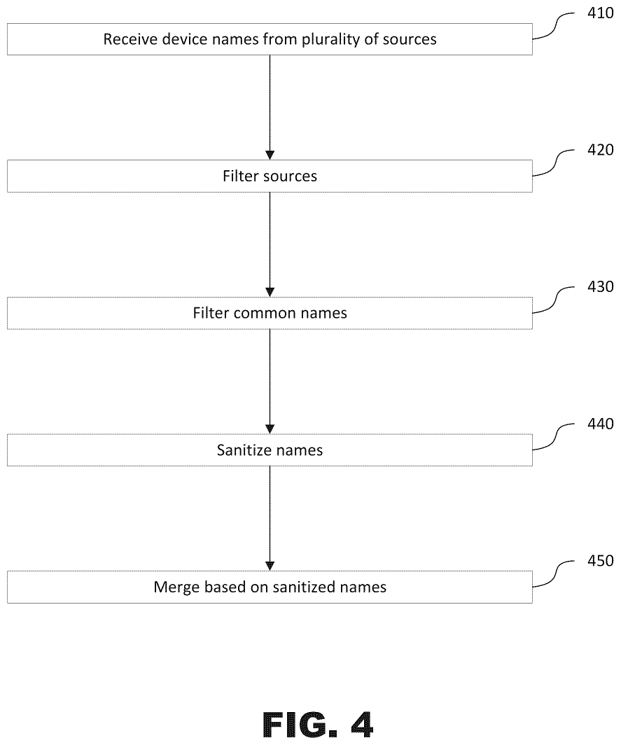

FIG. 4 is a flowchart that illustrates an example process for sanitizing device names according to some implementations. The process shown in FIG. 4 can be carried out on a computing system.

At step 410, the system can receive device names from a plurality of sources (e.g., Active Directory, mobile device management platforms, security platforms, Amazon Web Services, etc.). At step 420, the system can filter sources. For example, it can be known that certain sources of device names are inaccurate and thus should not be used or should be given lower priority or influence over the final determination of a device name. At step 430, the system can filter out common names or strings that appear in device names. For example, common strings that appear in device names include MACBOOK, IPHONE, DESKTOP, NOTEBOOK, LAPTOP, etc. In some implementations, filtering can be performed at a global level (e.g., without regard to which particular organization devices belong to). In some implementations, filtering can be performed at an organization level. For example, an organization may use a common naming scheme for its devices, such as “<employee_last_name>_<device_type_>_<office_location>.” At step 440, the system can sanitize names, as described in more detail herein. At step 450, the system can merge the sanitized names to determine a single name for a particular device.

In some implementations, the process of FIG. 4 can be implemented as a cloud service, and filtering common names, sources, and so forth can be performed at a global level (e.g., considering data from some or all organizations for which the cloud service has data). In some implementations, filtering common names, sources, and so forth can be performed for a single organization or group of organizations.

While FIG. 4 provides a general process for sanitizing device names, there are many possible implementations of such a process. In some implementations, fuzzy matching can be used. For example, the Levenshtein distance is a string metric that can be used to measure the difference between two strings. The Levenshtein distance can be the minimum number of single-character modifications (e.g., insertions, deletions, substitutions) required to transform a first string into a second string. In some implementations, device names without a particular Levenshtein distance of one another can be determined to be the same device. In some implementations, clustering with term frequency-inverse document frequency and bidirectional encoder representations from transformers (BERT) embeddings can be used.

In some implementations, an entropy-based approach can be used to identify device names. For example, a most important token can be based on maximum entropy among a series of names. For example, if an organization uses a naming scheme such as “LOCATION-DEVICETYPE-RANDOMSTRING” (e.g., “SFO-LAPTOP-123ABC”), the location and device type may have little variation, while the random string has a high degree of variation. In some implementations, a device name could be identified as RANDOMSTRING and the LOCATION and DEVICETYPE can be dropped. However, in some implementations, it can be significant not to drop too much of a string. For example, there may be another computer on the network that is called “NYC-LAPTOP-123ABC.” In such as case, it can be important that the location portion of the device name be retained, as otherwise NYC-LAPTOP-123ABC and SFO-LAPTOP-123ABC may be considered as the same asset. According to some implementations herein, a sanitized device name that is not unique may not prevent accurate identification of devices. For example, while a sanitized device name can be shared by more than one asset, other information (e.g., operating system, MAC address, installed application, logged in user, user agent, etc.) can be used to differentiate between devices with the same sanitized device name.

In some implementations, generative AI models (e.g., an LLM such as Falcon-7b, Falcon-7b-instruct, OpenLllama, XGen, etc.) can be used to identify device names. For example, device names and other information can be provided as a prompt for a large language model, and the large language model can be instructed to output a sanitized list of device names. However, such an approach can result in hallucinations in which non-existent devices are identified or devices are assigned names that are inconsistent with the data provided to the language model. In some cases, memory usage can be significant, which can make it difficult to deploy such an approach to identifying devices.

In some cases, device names can be determined using regular expressions. Such an approach can be highly effective if assets follow a well-defined, consistently-used naming scheme. However, this often is not the case. For example, desktops and laptops may follow one naming scheme, while servers may follow another, and IoT devices may follow yet another naming scheme. In some cases, multiple naming schemes may be used for the same types of devices. For example, security cameras in one facility may be named according to one convention, while security cameras in another facility may be named according to another, different convention.

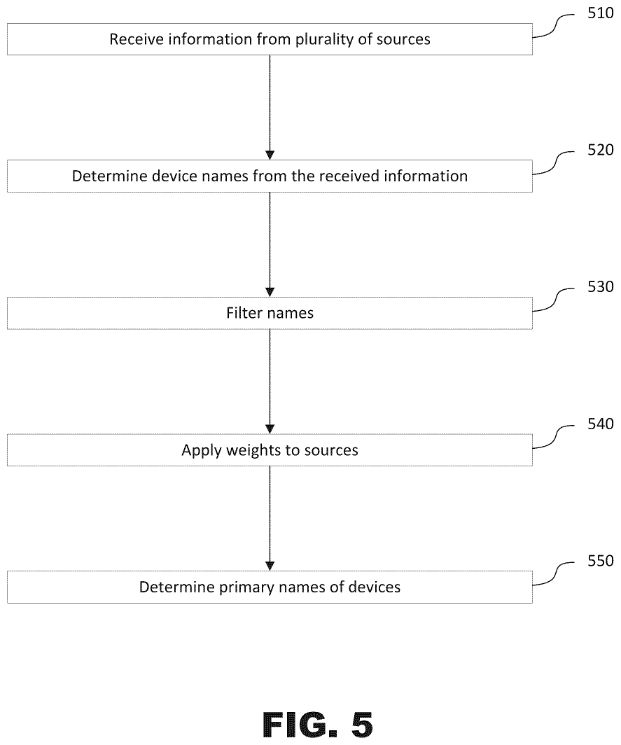

FIG. 5 is a flowchart that illustrates an example process for determining primary names of devices according to some implementations. At step 510, a computing system can receive information from a plurality of sources. The information can include device names. At step 520, the computing system can determine device names from the received information. At step 530, the system can filter the device names, for example to exclude certain device names or portions of device names (e.g., to remove common strings, domain names, etc.). At step 540, the computing system can apply weights to the source of the plurality of sources. For example, a more reliable source of device name information can be assigned a higher weight than a less reliable source of device name information. At step 550, the computing system can determine the primary names of one or more devices.

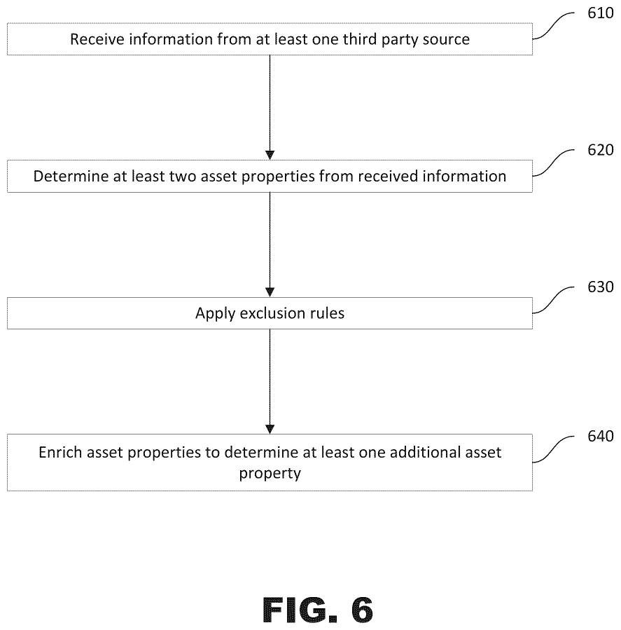

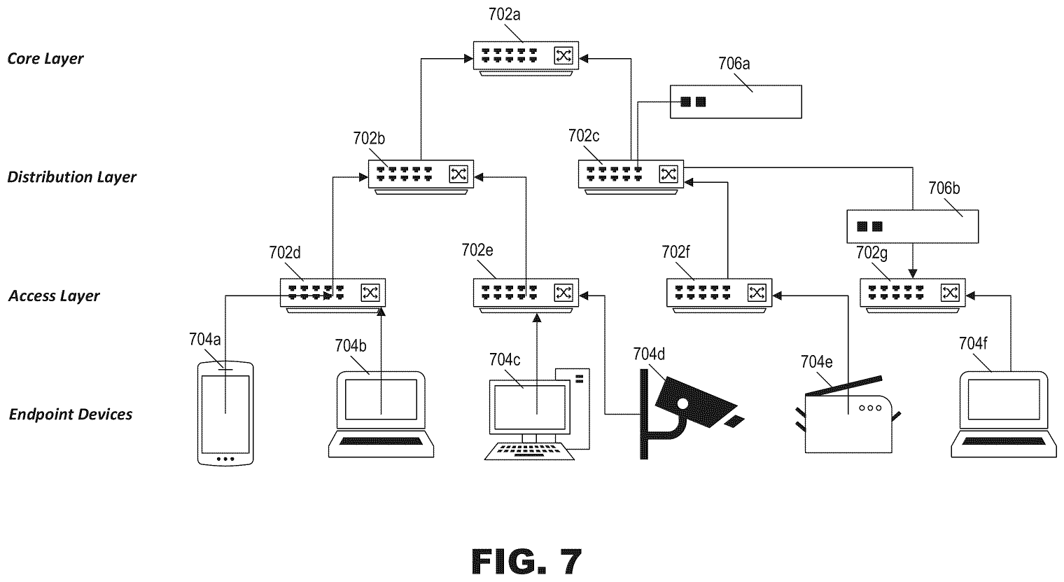

FIG. 6 is a flowchart that illustrates an example process for enriched asset properties according to some implementations. The enriching can include determining at least one additional asset property. At step 610, a computing system can receive information from at least one third party source, such as a domain controller, identity and access management (IAM) system, mobile device management (MDM) system, security software, telemetry data, etc. At step 620, the computing system can, using the received information, determine at least two asset properties. For example, the computing system can determine operating system and operating system version. At step 630, the computing system can apply one or more exclusion rules. The exclusion rules can, for example, exclude certain sources of data for one or more asset properties (e.g., a source may be known to be a poor indicator of a particular asset property, such as processor architecture), the exclude combinations of asset properties, etc. For example, the exclusion rules can exclude combinations of asset properties that are mutually exclusive (e.g., a processor cannot be both an APPLE SILICON processor and have an AMD64 instruction set architecture). At the 640, the computing system can enrich asset properties to determine at least one additional asset property.

While in FIG. 6, two asset properties are known and at least a third asset property is determined, it can be the case that additional asset properties are determined based on a single known asset property. For example, if a processor type is determined to be APPLE SILICON, it can be inferred that the asset is manufactured by APPLE, as no other manufacturers produce computers utilizing APPLE SILICON. In some cases, asset properties can be inferred if a confidence or likelihood of the asset property being true exceeds a threshold value. Continuing with the example of a computer using APPLE SILICON, in some cases it can be inferred that the computer runs the MACOS operating system, as this is a highly likely scenario. However, in some cases, such inferences may not be made. For example, it could be the case that an APPLE SILICON system is running WINDOWS in a virtual machine, is running LINUX on bare hardware, etc.

FIG. 7 is a diagram that illustrates an example network architecture according to some implementations. In FIG. 7, a three-layer network is illustrated, but it will be appreciated that the number of layers can vary. In FIG. 7, a network includes a core layer, a distribution layer, and an access layer. The core layer can be an uppermost layer that can, for example, connect the network to other networks such as the internet. Endpoint devices can connect to the access layer. The core layer can include a switch 702a. The switch 702a can be connected to a switch 702b and a switch 702c in the distribution layer. The switch 702b can be connected to a switch 702d and a switch 702e in the access layer. The switch 702c can be connected to a switch 702f and a switch 702g in the access layer. Endpoint devices 704a-704f can be connected to the switches 702d-702g in the access layer. The endpoint devices can include, for example, smartphones, laptops, desktops, security cameras, networked printers, or any other networked device.

In FIG. 7, the network includes a collector 706a. The collector 706a can be connected to the span port of the switch 702c and can monitor network traffic passing through the switch 702c. The network also includes a collector 706b operating as a network tap. The collector 706b can be positioned between the switch and the switch 702c and can monitor traffic passing from the switch 702g to the switch 702c. The collector 706b can pass traffic through from the switch 702g to the switch 702c. In contrast, the collector 706a, which is connected to a span port of the switch 702c, may not be configured to pass traffic through.

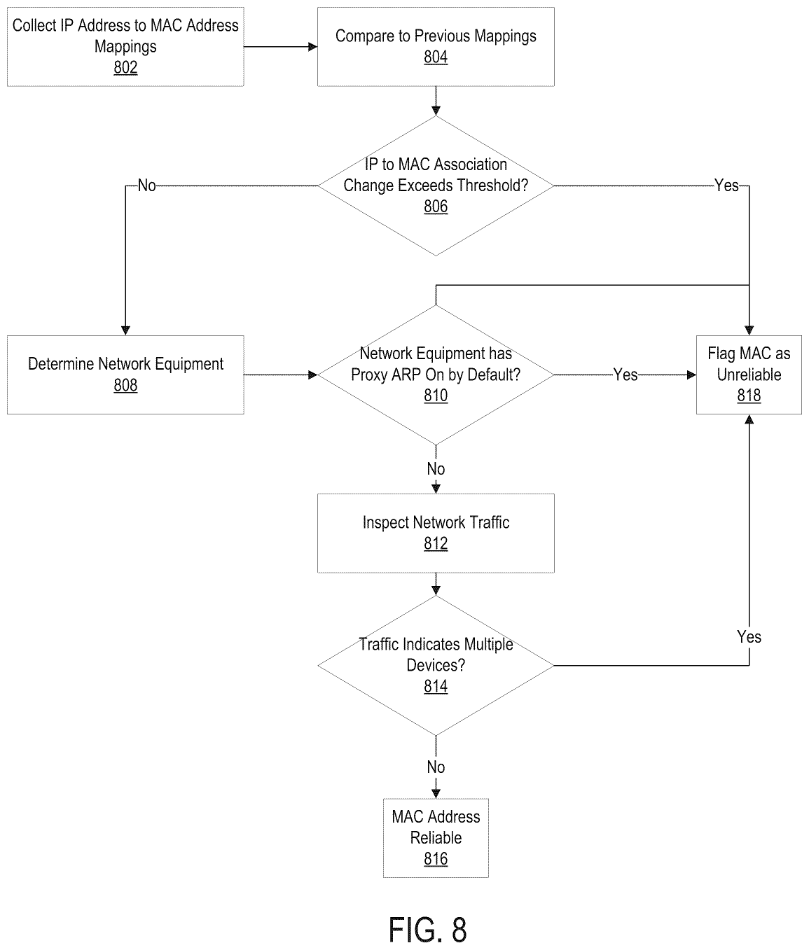

FIG. 8 is a flowchart that illustrates an example process for determining the reliability of a MAC address according to some implementations. At step 802, a computing system can collect IP address to MAC address mappings from one or more sources, such as switches, routers, device management systems, etc. At step 804, the computing system can compare the collected mappings to previous mappings, for example to determine changes in the mappings. At decision point 806, the computing system can determine if an IP to MAC association change exceeds a threshold value, for example if MAC address has been associated with more than a threshold number of IP addresses in less than a threshold amount of time. If the threshold(s) have been exceeded, the computing system can, at step 818, flag the MAC address as unreliable. If not, the computing system can, at step 808, determine the network equipment. For example, the computing system can determine a manufacturer of the network equipment, an operating system of the network equipment, etc. As described above, in some cases, some manufacturers or operating systems can be configured to enable services such as Proxy ARP by default. At decision point 810, the computing system can determine if the network equipment has Proxy ARP enabled by default. If so, the computing system can flag the MAC address as unreliable at step 818. If not, the computing system, at step 812, inspect network traffic. As described herein, the network traffic can indicate if multiple assets are associated with a single MAC address. For example, inspecting packet headers can indicate that multiple assets have their MAC address report as the single MAC address. At decision point 814, the computing system can determine if the traffic indicates multiple devices. If so, the computing system can flag the MAC address as unreliable at step 818. If not, the computing system can flag the MAC address as reliable at step 816.

### Machine Learning

A “model,” as used herein, can refer to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include neural networks, support vector machines, decision trees, Parzen windows, Bayes, clustering, reinforcement learning, probability distributions, decision trees, decision tree forests, and others. Models can be configured for various situations, data types, sources, and output formats.

In some implementations, a model can be a neural network with multiple input nodes. The input nodes can correspond to functions that receive the input and produce results. These results can be provided to one or more levels of intermediate nodes that each produce further results based on a combination of lower-level node results. A weighting factor can be applied to the output of each node before the result is passed to the next layer node. At a final layer, (“the output layer”) one or more nodes can produce a value classifying the input. In some implementations, such neural networks, known as deep neural networks, can have multiple layers of intermediate nodes with different configurations, can be a combination of models that receive different parts of the input and/or input from other parts of the deep neural network, or are convolutions—partially using output from previous iterations of applying the model as further input to produce results for the current input. In various implementations, the models of the present disclosure may be locally hosted, cloud managed, accessed via one or more Application Programming Interfaces (“APIs”), and/or any combination of the foregoing and/or the like. Additionally, in various implementations, the one or more models of the present disclosure may be implemented in or by electronic hardware such as computer processors.

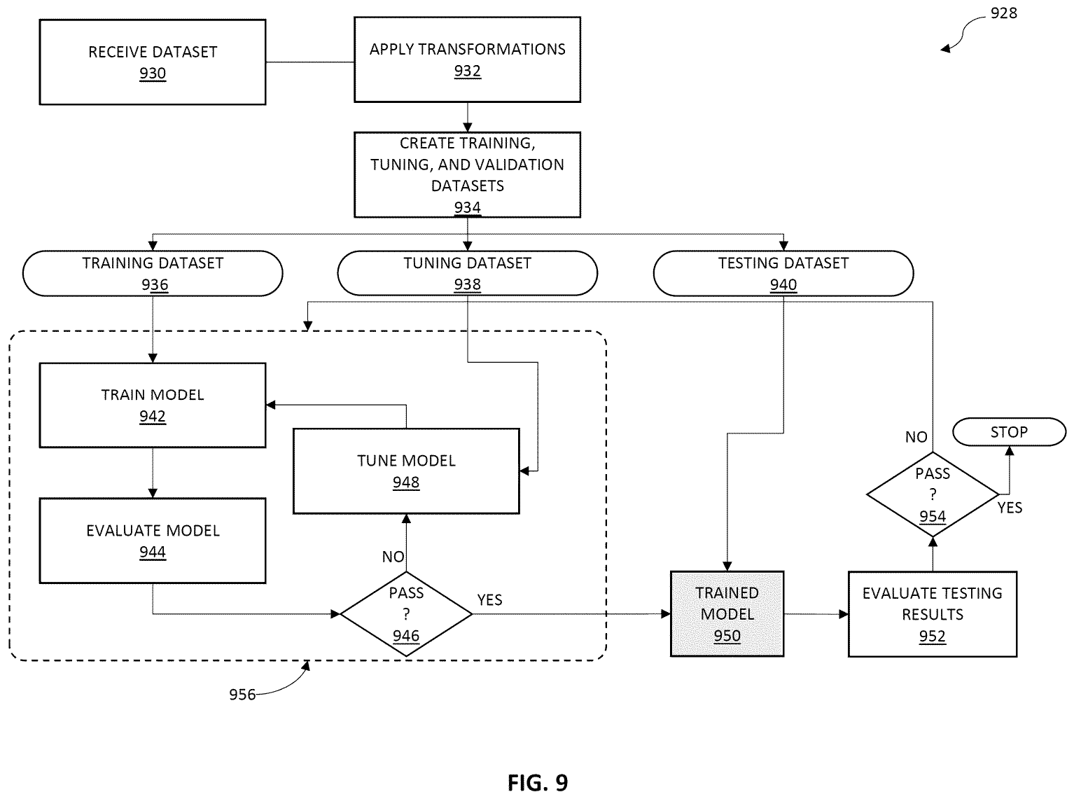

FIG. 9 depicts an example of a process in a flow diagram for training an artificial intelligence or machine learning model. The process 828 can be performed on a computing system. Various implementations of such a process for training an AI or ML model can include additional features and/or can exclude certain illustrated features (for example, when a transformed/preprocessed dataset is received such that “apply transformations” in block 932 does not need to be performed.)

As illustrated in the example of FIG. 9, at block 930 the system receives a dataset. At block 932, one or more transformations may be performed on the data in the dataset. In an example, data may require transformations to conform to expected input formats to conform with expected formatting, e.g., date formatting, units (e.g., pounds vs kilograms, Celsius vs Fahrenheit, inches vs centimeters, etc.), be of a consistent format, and the like. In some implementations, the data may undergo conversions to prepare it for use in training an AI or ML algorithm, for example, categorical data may be encoded in a particular manner. In some implementations, nominal data may be encoded using one-hot encoding, binary encoding, feature hashing, or other suitable encoding methods. In some implementations, ordinal data may be encoded using ordinal encoding, polynomial encoding, Helmert encoding, and so forth. In some implementations, numerical data may be normalized, for example by scaling data to a maximum of 1 and a minimum of 0 or −1. In some implementations, a dataset can include images, and the images can undergo resizing, orienting, color correction, and so forth, color space transformations, and so forth. These are merely examples, and the skilled artisan will readily appreciate that other transformations are possible.

At block 934, the system may create, from the received dataset, training, tuning, and testing/validation datasets. In some implementations, the training dataset 936 may be used during training to determine features for forming model that can be used for prediction, classification, and so forth. In some implementations, the tuning dataset 938 may be used to select final models (e.g., final model weights) and to prevent or correct overfitting that may occur during training with the training dataset 936, which can otherwise lead to poor generalization of the model. In some implementations, the testing dataset 940 may be used after training and tuning to evaluate the model. For example, in some implementations, the testing dataset 940 may be used to check if the model is overfitted to the training dataset. For example, when iterative training is used, overfitting can be indicated by continued improvement in the model performance on training data (e.g., the loss function or error continues to improve) while performance on a testing dataset improves for some period of time or number of training iterations, but then starts to decrease.

In some implementations, the system, in training loop 956, may train the model at block 942 using the training dataset 936. In some implementations, training may be conducted in a supervised, unsupervised, or partially supervised manner. In some implementations of the present disclosure, supervised training may be used. At 944, in some implementations, the system may evaluate the model according to one or more evaluation criteria. For example, in some implementations, the evaluation may include determining how well the model can determine image transformations to account for changes in image acquisition parameters. At 946, in some implementations, the system may determine if the model meets the one or more evaluation criteria. In some implementations, if the model fails evaluation, the system may, at 948, tune the model using the tuning dataset 938, repeating the training 942 and evaluation 944 until the model passes the evaluation at 946. In some implementations, once the model passes the evaluation at 946, the system may exit the model training loop 956. In some implementations, the testing dataset 936 may be run through the trained model 942 and, at block 944, the system may evaluate the results. In some implementations, if the evaluation fails, at block 946, the system may reenter training loop 956 for additional training and tuning. If the model passes, the system may stop the training process, resulting in a trained model 950. In some implementations, the training process may be modified. For example, in some implementations, the system may not use a tuning dataset 938. In some implementations, the model may not use a testing dataset 940.

In some implementations, testing can be performed within training loop 956, and training can be stopped once improvement in the model's performance on testing data stops improving or starts to decrease. For example, training can stop to avoid overfitting the model to the training data.

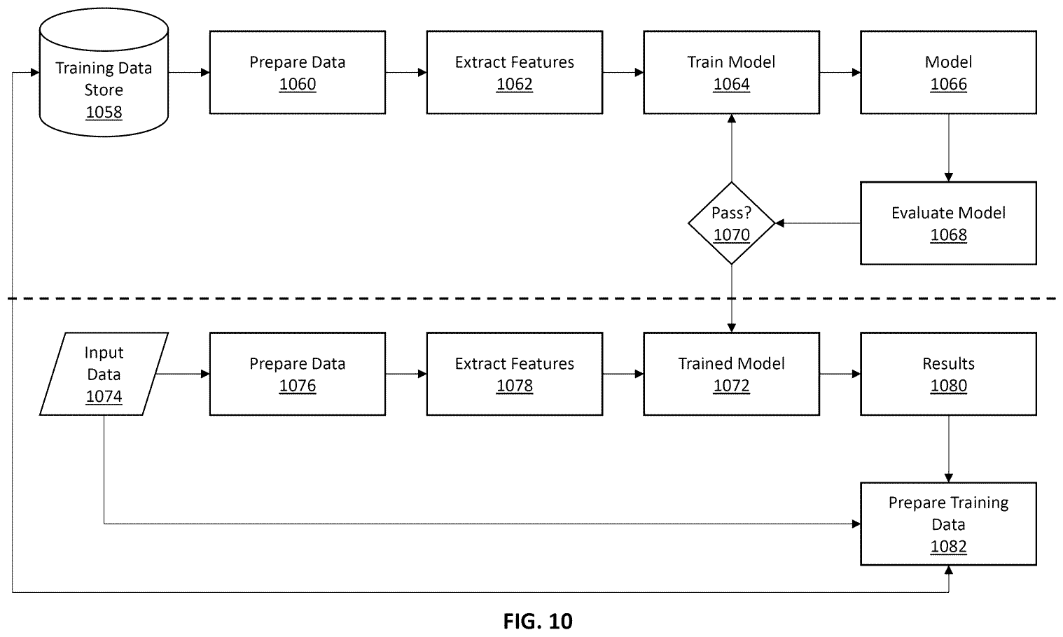

FIG. 10 illustrates an example of a process for training and using an AI/ML model. In some implementations, training data store 1058 can store data for training a model. For example, in some implementations, training data store 1058 can store a data for training the model. At block 1060, in some implementations, a system can be configured to prepare the training data if it was not previously prepared for use in training a model. In some implementations, as described briefly above, preparing the training data can include performing one or more normalization procedures, standardization procedures, and so forth, such as converting dates to a standard format, converting times to a standard format, and so forth. In some implementations, it can be desirable to exclude certain data as additional data can consume additional computing resources and it can take longer to train a model. However, in some implementations, exclusions may not be desirable as there can be a risk that a model may lose some predictive ability if data is excluded. At block 1062, the system can extract features from the training data and, at block 1064, can train the model using the training data to produce model 1066. At block 1068, in some implementations, the system can evaluate the model to determine if it passes one or more criteria. In some implementations, at decision point 1070, if the model fails, the system can perform additional training. In some implementations, if, at decision point 1070, the model passes, the system can make available trained model 1072, which can be the model 1072 after training is complete.

In some implementations, the trained model 1072 can be used to evaluate a particular input. The input data 1074 can relate to a specific input for which the outputs of the trained model 1072 are desired. At block 1076, the system can prepare the input data 1074, for example as described above in relation to the stored training data. In some implementations, at block 1078, the system can extract features from the prepared user data. In some implementations, the system can be configured to feed the extracted features to the trained model 1072 to produce results 1080.

In some implementations, the input data 1074, the results 1080, and/or other information can be used to train the model. At block 1082, in some implementations, the system can prepare the input data 1074 and the results 1080 for use in training the model 1072. In some implementations, the system can store the prepared data in training data store 1058. In some implementations, the prepared data can be stored, additionally or alternatively, in another database or data store. In some implementations, the system can retrain the model on periodically, continuously, or whenever an operator indicates to the system that the model should be retrained. Thus, in some implementations, the trained model 1072 can evolve over time, which can result in improved performance of the model (e.g., improved predictive capability, improved classification capability, and so forth) over time.

A dataset used for training can include, for example, Active Directory data, mobile device management data, network scan data, network monitoring data, virus scan data, telemetry data, and so forth. The training data store 1056 can include, for example, historical data and/or recent or real-time data. At step 1060, data can be manipulated in preparation for training, for example by altering values to conform to a standardized format, dropped some fields that are not used for training, and so forth. The input data 1074 can be data relating to a specific device or data relating to a collection of devices (e.g., all devices on a network). The results 1080 can be used determine unique assets. In some implementations, preparing the data step 1082 can include, for example, removing especially sensitive information, for example indications that an asset contains financial data, patient health information, and so forth.

In some implementations, a machine learning model can be trained using supervised learning, where the training data includes one or more inputs and a desired output, such as a predicted operating system. A representation of the input data be provided to the model. Output from the model can be compared to the desired output (e.g., to a correct output). For example, in a classification model, the desired output can be the true classification of the input, which can be compared with a classification determined by the model. In some implementations, based on the comparison, the model can be modified, such as by changing weights associated with nodes of the neural network or parameters of the functions used at each node in the neural network (e.g., applying a loss function). The model can be modified until it produces the desired output with a desired accuracy.

### Computer System

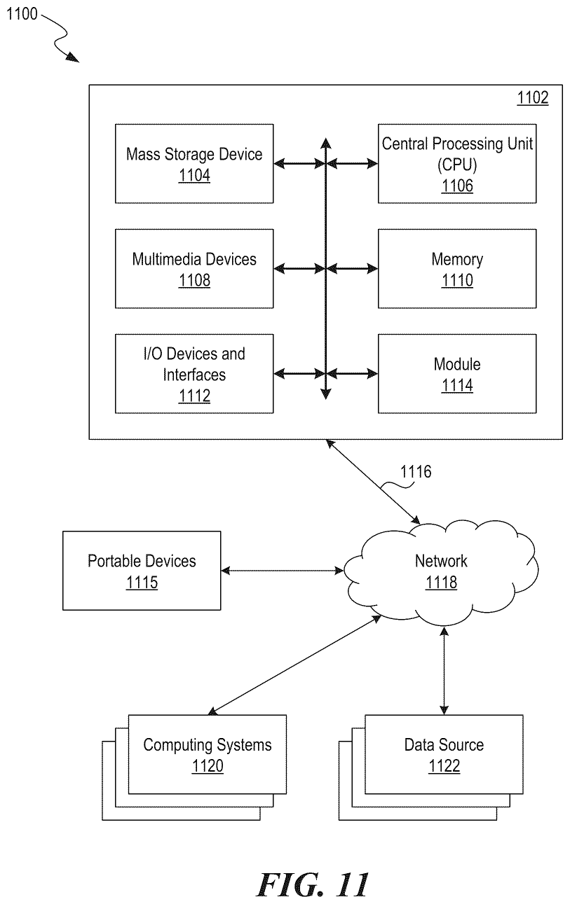

FIG. 11 is a block diagram 1100 depicting an implementation of a computer hardware system 1102 configured to run software for implementing for implemented one or more of the systems and methods described herein. The example computer system 1102 is in communication with one or more computing systems 1120 and/or one or more data sources 1122 via one or more networks 1118. While FIG. 11 illustrates an implementation of a computing system 1102, it is recognized that the functionality provided for in the components and modules of computer system 1102 may be combined into fewer components and modules, or further separated into additional components and modules.

The computer system 1102 can comprise a module 1114 that carries out the functions, methods, acts, and/or processes described herein. The module 1114 is executed on the computer system 1102 by a central processing unit 1106 discussed further below.

In general, the word “module,” as used herein, refers to logic embodied in hardware or firmware or to a collection of software instructions, having entry and exit points. Modules are written in a program language, such as JAVA, C or C++, PYTHON, or the like. Software modules may be compiled or linked into an executable program, installed in a dynamic link library, or may be written in an interpreted language such as BASIC, PERL, LUA, or PYTHON. Software modules may be called from other modules or from themselves, and/or may be invoked in response to detected events or interruptions. Modules implemented in hardware include connected logic units such as gates and flip-flops, and/or may include programmable units, such as programmable gate arrays or processors.

Generally, the modules described herein refer to logical modules that may be combined with other modules or divided into sub-modules despite their physical organization or storage. The modules are executed by one or more computing systems and may be stored on or within any suitable computer readable medium or implemented in-whole or in-part within special designed hardware or firmware. Not all calculations, analysis, and/or optimization require the use of computer systems, though any of the above-described methods, calculations, processes, or analyses may be facilitated through the use of computers. Further, in some implementations, process blocks described herein may be altered, rearranged, combined, and/or omitted.

The computer system 1102 includes one or more processing units (CPU) 1106, which may comprise a microprocessor. The computer system 1102 further includes a physical memory 1110, such as random-access memory (RAM) for temporary storage of information, a read only memory (ROM) for permanent storage of information, and a mass storage device 1104, such as a backing store, hard drive, rotating magnetic disks, solid state disks (SSD), flash memory, phase-change memory (PCM), 3D XPoint memory, diskette, or optical media storage device. Alternatively, the mass storage device may be implemented in an array of servers. Typically, the components of the computer system 1102 are connected to the computer using a standards-based bus system. The bus system can be implemented using various protocols, such as Peripheral Component Interconnect (PCI), Micro Channel, SCSI, Industrial Standard Architecture (ISA) and Extended ISA (EISA) architectures.

The computer system 1102 includes one or more input/output (I/O) devices and interfaces 1112, such as a keyboard, mouse, touch pad, and printer. The I/O devices and interfaces 1112 can include one or more display devices, such as a monitor, which allows the visual presentation of data to a user. More particularly, a display device provides for the presentation of GUIs as application software data, and multi-media presentations, for example. The I/O devices and interfaces 1112 can also provide a communications interface to various external devices. The computer system 1102 may comprise one or more multi-media devices 1108, such as speakers, video cards, graphics accelerators, and microphones, for example.

The computer system 1102 may run on a variety of computing devices, such as a server, a Windows server, a Structure Query Language server, a Unix Server, a personal computer, a laptop computer, and so forth. In other implementations, the computer system 1102 may run on a cluster computer system, a mainframe computer system and/or other computing system suitable for controlling and/or communicating with large databases, performing high volume transaction processing, and generating reports from large databases. The computing system 1102 is generally controlled and coordinated by an operating system software, such as z/OS, Windows, Linux, UNIX, BSD, SunOS, Solaris, MacOS, or other compatible operating systems, including proprietary operating systems. Operating systems control and schedule computer processes for execution, perform memory management, provide file system, networking, and I/O services, and provide a user interface, such as a graphical user interface (GUI), among other things.

The computer system 1102 illustrated in FIG. 11 is coupled to a network 1118, such as a LAN, WAN, or the Internet via a communication link 1116 (wired, wireless, or a combination thereof). Network 1118 communicates with various computing devices and/or other electronic devices, such as portable devices 1115. Network 1118 is communicating with one or more computing systems 1120 and one or more data sources 1122. The module 1114 may access or may be accessed by computing systems 1120 and/or data sources 1122 through a web-enabled user access point. Connections may be a direct physical connection, a virtual connection, and other connection type. The web-enabled user access point may comprise a browser module that uses text, graphics, audio, video, and other media to present data and to allow interaction with data via the network 1118.

Access to the module 1114 of the computer system 1102 by computing systems 1120 and/or by data sources 1122 may be through a web-enabled user access point such as the computing systems' 1120 or data source's 1122 personal computer, cellular phone, smartphone, laptop, tablet computer, e-reader device, audio player, or another device capable of connecting to the network 1118. Such a device may have a browser module that is implemented as a module that uses text, graphics, audio, video, and other media to present data and to allow interaction with data via the network 1118.

The output module may be implemented as a combination of an all-points addressable display such as a cathode ray tube (CRT), a liquid crystal display (LCD), a plasma display, or other types and/or combinations of displays. The output module may be implemented to communicate with interfaces 1112 and they also include software with the appropriate interfaces which allow a user to access data through the use of stylized screen elements, such as menus, windows, dialogue boxes, tool bars, and controls (for example, radio buttons, check boxes, sliding scales, and so forth). Furthermore, the output module may communicate with a set of input and output devices to receive signals from the user.

The input device(s) may comprise a keyboard, roller ball, pen and stylus, mouse, trackball, voice recognition system, or pre-designated switches or buttons. The output device(s) may comprise a speaker, a display screen, a printer, or a voice synthesizer. In addition, a touch screen may act as a hybrid input/output device. In another implementation, a user may interact with the system more directly such as through a system terminal connected to the score generator without communications over the Internet, a WAN, or LAN, or similar network.

In some implementations, the system 1102 may comprise a physical or logical connection established between a remote microprocessor and a mainframe host computer for the express purpose of uploading, downloading, or viewing interactive data and databases on-line in real time. The remote microprocessor may be operated by an entity operating the computer system 1102, including the client server systems or the main server system, an/or may be operated by one or more of the data sources 1122 and/or one or more of the computing systems 1120. In some implementations, terminal emulation software may be used on the microprocessor for participating in the micro-mainframe link.

In some implementations, computing systems 1120 who are internal to an entity operating the computer system 1102 may access the module 1114 internally as an application or process run by the CPU 1106.

In some implementations, one or more features of the systems, methods, and devices described herein can utilize a URL and/or cookies, for example for storing and/or transmitting data or user information. A Uniform Resource Locator (URL) can include a web address and/or a reference to a web resource that is stored on a database and/or a server. The URL can specify the location of the resource on a computer and/or a computer network. The URL can include a mechanism to retrieve the network resource. The source of the network resource can receive a URL, identify the location of the web resource, and transmit the web resource back to the requestor. A URL can be converted to an IP address, and a Domain Name System (DNS) can look up the URL and its corresponding IP address. URLs can be references to web pages, file transfers, emails, database accesses, and other applications. The URLs can include a sequence of characters that identify a path, domain name, a file extension, a host name, a query, a fragment, scheme, a protocol identifier, a port number, a username, a password, a flag, an object, a resource name and/or the like. The systems disclosed herein can generate, receive, transmit, apply, parse, serialize, render, and/or perform an action on a URL.

A cookie, also referred to as an HTTP cookie, a web cookie, an internet cookie, and a browser cookie, can include data sent from a website and/or stored on a user's computer. This data can be stored by a user's web browser while the user is browsing. The cookies can include useful information for websites to remember prior browsing information, such as a shopping cart on an online store, clicking of buttons, login information, and/or records of web pages or network resources visited in the past. Cookies can also include information that the user enters, such as names, addresses, passwords, credit card information, etc. Cookies can also perform computer functions. For example, authentication cookies can be used by applications (for example, a web browser) to identify whether the user is already logged in (for example, to a web site). The cookie data can be encrypted to provide security for the consumer. Tracking cookies can be used to compile historical browsing histories of individuals. Systems disclosed herein can generate and use cookies to access data of an individual. Systems can also generate and use JSON web tokens to store authenticity information, HTTP authentication as authentication protocols, IP addresses to track session or identity information, URLs, and the like.

The computing system 1102 may include one or more internal and/or external data sources (for example, data sources 1122). In some implementations, one or more of the data repositories and the data sources described above may be implemented using a relational database, such as DB2, Sybase, Oracle, CodeBase, and Microsoft® SQL Server as well as other types of databases such as a flat-file database, an entity relationship database, and object-oriented database, and/or a record-based database.

The computer system 1102 may also access one or more databases 1122. The databases 1122 may be stored in a database or data repository. The computer system 1102 may access the one or more databases 1122 through a network 1118 or may directly access the database or data repository through I/O devices and interfaces 1112. The data repository storing the one or more databases 1122 may reside within the computer system 1102.

### Conclusion

In the foregoing specification, the systems and processes have been described with reference to specific implementations thereof. It will, however, be evident that various modifications and changes may be made thereto without departing from the broader spirit and scope of the implementations disclosed herein. The specification and drawings are, accordingly, to be regarded in an illustrative rather than restrictive sense.

Indeed, although the systems and processes have been disclosed in the context of certain implementations and examples, it will be understood by those skilled in the art that the various implementations of the systems and processes extend beyond the specifically disclosed implementations to other alternative implementations and/or uses of the systems and processes and obvious modifications and equivalents thereof. In addition, while several variations of the implementations of the systems and processes have been shown and described in detail, other modifications, which are within the scope of this disclosure, will be readily apparent to those of skill in the art based upon this disclosure. It is also contemplated that various combinations or sub-combinations of the specific features and aspects of the implementations may be made and still fall within the scope of the disclosure. It should be understood that various features and aspects of the disclosed implementations can be combined with, or substituted for, one another in order to form varying modes of the implementations of the disclosed systems and processes. Any methods disclosed herein need not be performed in the order recited. Thus, it is intended that the scope of the systems and processes herein disclosed should not be limited by the particular implementations described above.

It will be appreciated that the systems and methods of the disclosure each have several innovative aspects, no single one of which is solely responsible or required for the desirable attributes disclosed herein. The various features and processes described above may be used independently of one another or may be combined in various ways. All possible combinations and sub-combinations are intended to fall within the scope of this disclosure.

Certain features that are described in this specification in the context of separate implementations also may be implemented in combination in a single implementation. Conversely, various features that are described in the context of a single implementation also may be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination. No single feature or group of features is necessary or indispensable to each and every implementation.

It will also be appreciated that conditional language used herein, such as, among others, “can,” “could,” “might,” “may,” “for example,” and the like, unless specifically stated otherwise, or otherwise understood within the context as used, is generally intended to convey that certain implementations include, while other implementations do not include, certain features, elements and/or steps. Thus, such conditional language is not generally intended to imply that features, elements and/or steps are in any way required for one or more implementations or that one or more implementations necessarily include logic for deciding, with or without author input or prompting, whether these features, elements and/or steps are included or are to be performed in any particular implementation. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one or more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other implementations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, other implementations are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the implementations are not to be limited to the particular forms or methods disclosed, but, to the contrary, the implementations are to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or implementation can be used in all other implementations or implementations set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (for example, as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (for example, as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain implementations require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the implementations shown herein but are to be accorded the widest scope consistent with this disclosure, the principles and the novel features disclosed herein.

1. A computer-implemented method for asset identification and consolidation in a network, the computer-implemented method comprising:
receiving, by a computing system from at least one source, data comprising a plurality of media access control (MAC) addresses corresponding to each of a plurality of assets in the network;
analyzing, by the computing system, the received plurality of MAC addresses to determine one or more MAC addresses of the plurality of MAC addresses that are repeated in the received data;
labeling, by the computing system, the repeated MAC addresses for exclusion in identifying each of the plurality of assets,
wherein the computing system comprises a processor and a memory.

2. The computer-implemented method of claim 1, wherein the at least one source comprises agent-based security software, agentless security software, monitoring software, or an identity and access management (IAM) service.

3. The computer-implemented method of claim 1, wherein the at least one source comprises a single source.

4. The computer-implemented method of claim 1, further comprising detecting, prior to receiving data by the computing system, connection of a new asset of the plurality of assets to the network.

5. The computer-implemented method of claim 1, further comprising:
receiving, by the computing system from the at least one source, one or more additional asset identifiers corresponding to each of the plurality assets in the network;
training a machine learning model using training data comprising asset identifiers and relationships between the asset identifiers to generate a trained machine learning model;
extracting one or more features from the one or more additional asset identifiers;
inputting the one or more extracted features to the trained machine learning model to determine a classification identifier of each of the plurality of assets in the network.

6. The computer-implemented method of claim 5, wherein the one or more additional asset identifier comprises a hardware manufacturer or hardware model and the classification identifier comprising an operating system.

7. The computer-implemented method of claim 5, wherein the machine learning model comprises a binary classification model.

8. The computer-implemented method of claim 5, wherein the machine learning model comprises a multi-classification model.

9. The computer-implemented method of claim 8, wherein the machine learning model comprises a k-nearest neighbors model, decision tree, Naïve Bayes model, random forest, or gradient boosting model.

10. The computer-implemented method of claim 5, wherein the machine learning model comprises a plurality of binary classification models.

11. The computer-implemented method of claim 1, wherein labeling the repeated MAC addresses comprises modifying or adding a field to a database table comprising a plurality of asset identifiers.

12. The computer-implemented method of claim 1, wherein labeling the repeated MAC addresses comprises adding entries to a table of repeated MAC addresses.

13. The computer-implemented method of claim 1, wherein the at least one source comprises a plurality of sources, and wherein the computer-implemented method further comprises:
determining a device name associated with each of the plurality of MAC addresses in the received data;
determining one or more MAC addresses of the plurality of MAC addresses that are associated with more than one device name; and
excluding the one or more MAC addresses of the plurality of MAC addresses that are associated with more than one device name from use as an identifier for asset identification.

14. The computer-implemented method of claim 1, wherein the at least one source comprises a plurality of sources, and wherein the computer-implemented method further comprises:
determining a device name associated with each of the plurality of MAC addresses in the received data;
determining one or more MAC addresses of the plurality of MAC addresses that are associated with more than one device name; and
labeling the one or more MAC addresses of the plurality of MAC addresses that are associated with more than one device name as a weak identifier for asset identification.

15. A computer-implemented method for asset identification and consolidation in a network, the computer-implemented method comprising:
receiving, by a computing system from a plurality of sources, data comprising a plurality of asset identifiers corresponding to a plurality of assets in the network;
determining, by the computing system, a first asset identifier from a first source of the plurality of sources, the first asset identifier corresponding to an asset of the plurality of asset;
generating, by the computing system, a first listing of the asset within an asset listing;
determining, by the computing system, a second asset identifier from a second source of the plurality of sources corresponding to the asset;
generating, by the computing system, a second listing of the asset within the asset listing;
identifying, by the computing system, the first identifier and the second identifier in data received from a third source of the plurality of sources;
determining, by the computing system, that the first identifier and the second identifier comprise shared identifiers of the asset; and
consolidating, by the computing system, the asset listing by removing the first listing or the second listing of the asset from the asset listing or merging the first listing and the second listing of the asset in the asset listing,
wherein the computing system comprises a processor and a memory.

16. A computer-implemented method for asset identification and consolidation in a network, the computer-implemented method comprising:
receiving, by a computing system from a plurality of sources, data comprising a plurality of device names corresponding to each of a plurality of assets in the network;
filtering, by the computing system, strings from the plurality of device names, wherein the strings correspond to a list of predetermined device name strings;
sanitizing, by the computing system, the filtered device names to determine the device name corresponding to each of the plurality of assets in the network;
determining, by the computing system, at least one repeated device name within the sanitized device names; and
merging, by the computing the system, the repeated device names in a list of device names corresponding to each of the plurality of assets in the network,
wherein the computing system comprises a processor and a memory.

17. The computer-implemented method of claim 16, wherein sanitizing the filtered device names comprises:
fuzzy matching the filtered device names;
calculating a Levenshtein distance between the filtered device names; or
using clustering with term frequency-inverse document frequency and bidirectional encoder representations from transformers (BERT) embeddings.

18. The computer-implemented method of claim 16, wherein sanitizing the filtered device names comprises identifying a token of the filtered device name based on a calculated maximum entropy measurement of at least a subset of the filtered device names.

19. The computer-implemented method of claim 16, wherein sanitizing the filtered device names comprises providing the filtered device names in a prompt to a large language model (LLM).

20. The computer-implemented method of claim 19, wherein the LLM comprises Falcon-7b, Falcon-7b-instruct, OpenLllama, or XGen.
